(19) United States
(12) Patent Application Publication
(10) Pub. No.: US 2026/0317640 A1
(43) Pub. Date: Oct. 15, 2026

(54) INTEGRATED ETHYLENE PLANT AND STEAM REFORMER

(71) Applicant: Lummus Technology LLC, Houston, TX (US)

(72) Inventors: Jose De Barros, Houston, TX (US); Kandasamy M. Sundaram, Houston, TX (US); Ronald M. Venner, Houston, TX (US)

(73) Assignee: Lummus Technology LLC, Houston, TX (US)

(21) Appl. No.: 19/648,633

(22) Filed: Apr. 15, 2026

Related U.S. Application Data
(60) Provisional application No. 63/789,273, filed on Apr. 15, 2025.

(51) Int. Cl. C10G 55/04; C01B 3/382

(52) U.S. Cl. CPC C10G 55/04; C01B 3/382; C01B 2203/0233; C01B 2203/0283; C01B 2203/062; C01B 2203/0822; C01B 2203/085; C01B 2203/0855; C01B 2203/1241; C10G 2300/201; C10G 2300/4012; C10G 2300/4043; C10G 2300/4081; C10G 2300/42; C10G 2400/20

(57) ABSTRACT

A process for minimizing carbon dioxide emissions when producing olefins includes providing a hydrocarbon feed and a hydrogen containing fuel to a cracking heater of a thermal cracking unit. Combusting the hydrogen containing fuel in burners of the heater provides energy to crack the hydrocarbon feed to produce a cracker effluent including hydrogen, methane, C2-C4 olefins, C2-C10 paraffins, naphthenes, aromatics, and pyrolysis fuel oil. Separating the cracker effluent recovers a methane stream and hydrocarbon fractions including the C2-C4 olefins, and C2-C10 paraffins, naphthenes, and aromatics. The methane stream is fed to a steam reforming unit. Reforming methane in the steam reforming unit produces a reformer effluent including hydrogen and one or more of unreacted methane, carbon monoxide, and carbon dioxide. The hydrogen in the reformer effluent is fed to the cracking heater as the hydrogen containing fuel. Methods for starting up an integrated reforming and cracking system are also included.

### BACKGROUND

Ethylene is produced by the thermal cracking of hydrocarbons in fired heaters. The fired heaters use fossil fuels and produce a considerable amount of carbon dioxide (CO₂). To reduce the amount of CO₂ emissions to zero, hydrogen may be used as a fuel for the fired heaters. Burning hydrogen produces water only. However, not enough hydrogen is produced in the production of ethylene to meet the reaction duty of thermal cracking. Steam methane reforming also produces hydrogen, but also uses fired heaters. By integrating thermal cracking processes with steam methane reforming, sufficient hydrogen may be produced to fuel-fired heaters and thereby reduce the emissions of CO₂.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a process for minimizing carbon dioxide emissions when producing olefins. The process may include providing a hydrocarbon feed and a hydrogen containing fuel to a cracking heater of a thermal cracking unit. Combusting the hydrogen containing fuel in burners of the cracking heater may provide energy to crack the hydrocarbon feed to produce a cracker effluent including hydrogen, methane, C2-C4 olefins, C2-C10 paraffins, naphthenes, aromatics, and pyrolysis fuel oil. Separating the cracker effluent may recover a methane stream and one or more hydrocarbon fractions including the C2-C4 olefins, and C2-C10 paraffins, naphthenes, and aromatics. The methane stream may be fed to a steam reforming unit. Reforming the methane in the steam reforming unit may produce a reformer effluent including hydrogen and one or more of unreacted methane, carbon monoxide, and carbon dioxide. The hydrogen in the reformer effluent may be fed to the cracking heater as the hydrogen containing fuel.

In another aspect, embodiments disclosed herein relate to a system for minimizing carbon dioxide emissions when thermally cracking hydrocarbons to produce olefins. The system may include feeding the reformer effluent to a reformer separation system to produce a carbon dioxide stream and a CO2-lean stream comprising hydrogen, carbon monoxide, and unreacted methane. Feeding the cracker effluent to a first cracker separation system may produce a hydrogen-rich stream and a hydrocarbon-rich stream. Feeding the CO2-lean stream and the hydrogen-rich stream to a second cracker separation system, and collectively separating the CO2-lean stream and the hydrogen-rich stream may recover a hydrogen stream and a retentate stream including the unreacted methane, where feeding the hydrogen in the reformer effluent may include feeding the hydrogen stream to the cracking heater as the hydrogen containing fuel.

In yet another aspect, embodiments disclosed herein relate to a method for starting up an integrated reforming and cracking system. The method may include reforming methane in an electrically heated reforming reactor to produce hydrogen. Starting up a fuel-fired reforming reactor using a portion of the hydrogen as a fuel and reforming methane in the fuel-fired reforming reactor may produce additional hydrogen. Starting up a cracking heater using a hydrogen produced in the electrically heated reforming reactor and the fuel-fired reforming reactor and thermally cracking a hydrocarbon feed may produce olefins and methane. The method may then include feeding the methane produced in the cracking heater as methane feed one or both of the electrically heated reforming reactor and the fuel-fired reforming reactor.

Other aspects and advantages of the claimed subject matter will be apparent from the following description and the appended claims.

### BRIEF DESCRIPTION OF DRAWINGS

FIG. 1 is a generic flow scheme of a process, according to one or more embodiments.

FIG. 2 is a flow scheme of an integration, according to one or more embodiments.

FIG. 3 is a flow scheme of an integration, according to one or more embodiments.

FIG. 4 is an example steam reforming unit with a fired heater, according to one or more embodiments.

FIG. 5 is an example equilibrium curve for methane steam reforming, according to one or more embodiments.

FIG. 6 is an example steam reforming unit with a fuel-fired reforming reactor and an electrically heated reforming reactor, according to one or more embodiments.

FIG. 7 is an example of a pressure swing adsorption system and a membrane separation system, according to one or more embodiments.

FIG. 8 is an example of a thermal cracking unit, according to one or more embodiments.

FIG. 9 is a graph of carbon dioxide reduction as a function of hydrogen content, according to one or more embodiments.

### DETAILED DESCRIPTION

In one aspect, embodiments disclosed herein relate to systems and processes for minimizing carbon dioxide (CO₂) emissions when producing olefins by thermal cracking. Minimizing CO₂ emissions may occur by integrating a thermal cracking unit with a steam reforming unit. Hydrogen produced during the steam methane reforming (SMR) may be used as fuel in fired reactors in the thermal cracking unit, replacing carbon-based fuels. Carbon-based fuels produce high amounts of CO₂ emissions. Methane produced by the thermal cracking unit may be used to feed the steam reforming unit. Additionally, hydrogen produced by the thermal cracking unit or the steam reforming unit may be used as fuel for fired heaters in the steam reforming unit. By integrating the thermal cracking unit with the steam reforming unit, zero CO₂ emissions may be produced. Thus, the systems and processes as described herein may produce olefins at a commercial scale while producing limited CO₂ emissions.

### Process for Minimizing Co2 Emissions

In one or more embodiments, a process for minimizing CO2 emissions when producing olefins via thermal cracking includes providing a hydrocarbon feed and a hydrogen containing fuel to a cracking heater of a thermal cracking unit. Combusting the hydrogen containing fuel in burners of the cracking heater may provide the energy for the thermal cracking unit to crack the hydrocarbon feed. Cracking produces a cracker effluent which may include hydrogen, methane, C2-C10 olefins, C2-C10 paraffins, naphthenes, and aromatics. Separating the cracker effluent may recover a methane stream and one or more hydrocarbon fractions comprising the C2-C10 olefins, C2-C10 paraffins, and aromatics.

The process may then include feeding the methane stream to a steam reforming unit. Reforming the methane in the steam reforming unit may produce a reformer effluent including hydrogen and one or more of unreacted methane, carbon monoxide, and carbon dioxide. The process may then include feeding the hydrogen in the reformer effluent to the cracking heater as the hydrogen containing fuel.

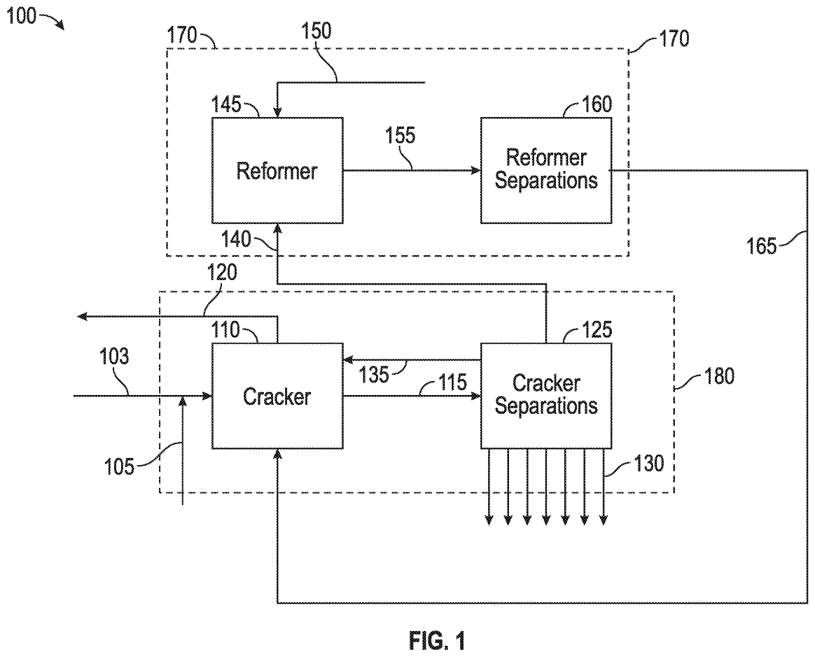

FIG. 1 depicts a generic flow scheme of the process for minimizing CO₂ emissions when producing olefins by thermal cracking. As shown in FIG. 1, the process 100 may include providing a hydrocarbon feed via a feed line 103 to a cracking heater 110 in a thermal cracking unit 180. The hydrocarbon feed may be mixed with steam provided by line 105. The steam may be clean or dirty steam. Dirty steam may include trace levels of impurities such as hydrogen. The hydrogen may be present in the dirty steam at a parts per million (ppm) level. A hydrogen containing fuel may also be provided to the cracking heater 110.

The process 100 may then include combusting the hydrogen containing fuel in burners of the cracking heater 110 to provide energy to crack the hydrocarbon feed to produce a cracker effluent including hydrogen, methane, C2-C4 olefins, C2-C10 paraffins, naphthenes, and aromatics. It may also produce species heavier than C10 which are separated as pyrolysis fuel oil. The cracker effluent may be directed via effluent line 115 to a cracker separation system 125. The cracker separation system 125 may include a quench system, a first compression system, a caustic wash system, a second compression system, a dryer, a chilling train, a demethanizer, a pressure swing adsorption system, a membrane separation system, and combinations thereof. Separating the cracker effluent may recover a methane stream 140. The methane stream 140 may also include ethane, propane, or combinations thereof. Fractions of heavier hydrocarbons 130 (i.e., C2-C4 olefins, C2-C10 paraffins, and aromatics) recovered from the cracker separation system 125 may be recycled via line 135 back to the cracking heater 110 for additional cracking. Combustion products 120 from cracking the hydrocarbon feed in the cracking heater 110 may be produced. The combustion products may include water and CO₂. The CO₂ may be captured to prevent additional CO₂ emissions.

The process 100 may include feeding the methane stream 140 to a reformer 145 in a steam reforming unit 170. The reformer 145 may include a fuel-fired reforming reactor, an electrically heated reforming reactor, or combinations thereof. The reformer 145 may reform the methane, producing a reformer effluent. The reformer effluent may include hydrogen and one or more of unreacted methane, carbon monoxide, and carbon dioxide. A steam line 150 may be configured to provide steam to the reformer 145. The steam may be clean steam for reacting with the methane in the reformer 145.

After reforming, the process may include feeding the reformer effluent to a reformer separation system 160 via effluent line 155. The reformer separation system 160 may include a carbon capture system, a pressure swing adsorption system, a membrane separation system, or combinations thereof. A hydrogen stream, a carbon dioxide stream, and an unreacted methane stream may be recovered from the reformer separation system 160. The carbon dioxide stream may be sequestered or converted to other chemicals. The sequester of CO₂ in the reformer separation system 160 may minimize the amount of CO₂ emissions. The process may further include feeding the unreacted methane stream via a second recycle line (not pictured) to the reformer 145 of the steam reforming unit 170 continued conversion. Additionally, the unreacted methane stream may be fed as a fuel to burners of the steam reforming unit 170, to burners of the thermal cracking unit 180, or a combination thereof.

The hydrogen stream may be purified in the reformer separation system 160. The process may include directing the hydrogen stream to the cracking heater 110 as a hydrogen containing fuel via recycle line 165. The hydrogen containing fuel may also include carbon monoxide and unreacted methane. Additionally, a portion of hydrogen in the reformer effluent may be fed to a burner of the steam reforming unit 170 as a fuel. The use of hydrogen produced by the steam reforming unit 170 as the hydrogen containing fuel in the cracking heater 110 may minimize the amount of CO₂ emissions, as a hydrocarbon containing fuel is not being used.

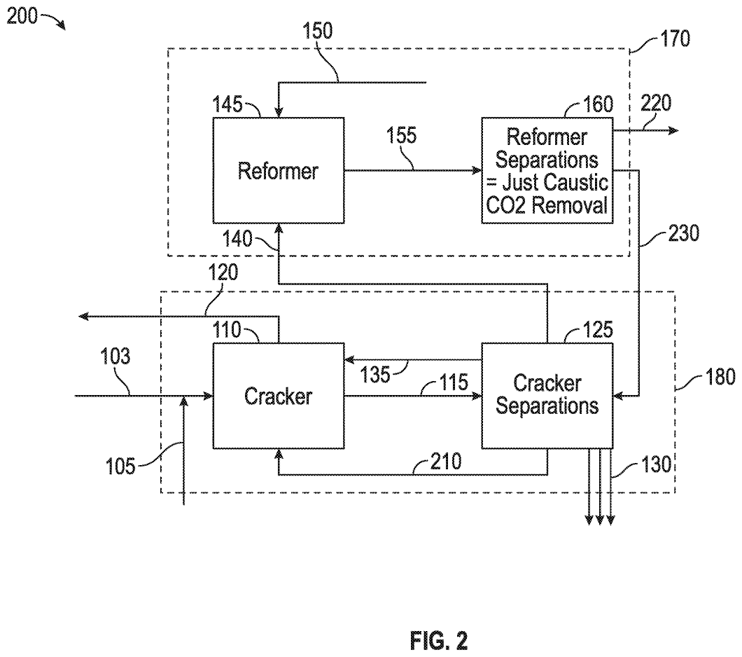

The process for minimizing CO₂ emissions may include multiple integrations. A first example integration 200 is depicted in FIG. 2. The process for the first example integration 200 may include the same steps as described previously in respect to FIG. 1. The process may include producing a cracker effluent and a reformer effluent, where the reformer effluent includes hydrogen, unreacted methane, carbon monoxide and carbon dioxide. In one or more embodiments, the reformer effluent is fed to a reformer separation system 160 to produce a carbon dioxide stream and a CO2-lean stream. The carbon dioxide stream may be produced by a caustic wash in the reformer separation system. The carbon dioxide stream may be recovered via line 220. The CO2-lean stream may include hydrogen, carbon monoxide, and unreacted methane. The CO2-lean stream is fed via effluent line 230 to the cracker separation system 125.

The cracker separation system 125 may include a first cracker separation system and a second cracker separation system. Feeding a cracker effluent to the first cracker separation system may produce a hydrogen-rich stream and a hydrocarbon-rich stream. The hydrogen-rich stream may include hydrogen, carbon monoxide, and unreacted methane. Feeding the CO2-lean stream and the hydrogen-rich stream to the second cracker separation system and collectively separating the CO2-lean stream and the hydrogen-rich stream may recover a hydrogen stream and a retentate stream including the unreacted methane. The hydrogen may be fed via fuel line 210 to the cracking heater 110 as a hydrogen containing fuel. Thus, the process according to first example integration 200 may also include when feeding the hydrogen in the reformer effluent, feeding the hydrogen stream to the cracking heater as the hydrogen containing fuel.

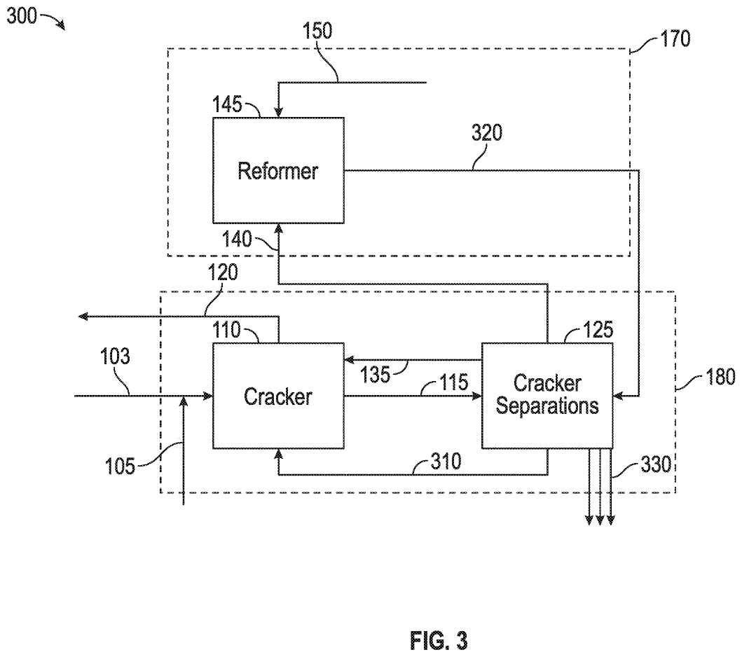

A second example integration 300 is depicted in FIG. 3. The process for the second example integration 300 may include the same steps as described previously in respect to FIG. 1. The process may include producing a reformer effluent and a cracker effluent. The reformer effluent may include hydrogen, unreacted methane, carbon monoxide and carbon dioxide. The process may include feeding the reformer effluent to a cracker separation system 125 via effluent line 320. The process may also include feeding the cracker effluent via effluent line 115 to the cracker separation system 125. Collectively separating the cracker effluent and the reformer effluent may recover a carbon dioxide stream, a methane stream, and a hydrogen stream. Fractions of heavier hydrocarbons 330 may further be recovered. The hydrogen stream may be fed via fuel line 310 to the cracking heater 110 as a hydrogen containing fuel. Thus, the process according to second example integration 300 may also include when feeding the hydrogen in the reformer effluent, feeding the hydrogen stream to the cracking heater as the hydrogen containing fuel.

The process 100 may include, when separating the cracker effluent, recovering an ethane stream and a propane stream. The process may include feeding one or both of the ethane stream and the propane stream to the steam reforming unit. The steam reforming unit may reform the ethane, the propane, or both the ethane and the propane. Additional hydrogen may be produced from this reforming. The additional hydrogen may be fed as a hydrogen containing fuel to a cracking heater in the thermal cracking unit. The additional hydrogen may also be fed as a fuel to a heater in the steam reforming unit.

The process 100 may include generating steam using excess heat in the steam reforming unit. The steam may be high pressure (HP) or super high pressure (SHP). HP steam may have a pressure ranging from 40 to 100 bar. SHP steam may have a pressure of at least 100 bar. A portion of the steam generated in the steam reforming unit may be fed to the thermal cracking unit as a feed steam stream, a utility steam stream, or both as a feed steam stream and a utility steam stream.

### System for Minimizing CO2 Emissions

A system for minimizing CO₂ emissions when thermally cracking hydrocarbons to produce olefins may include a steam reforming unit. The steam reforming unit may be configured to reform methane in a methane stream to produce a reformer effluent. The reformer effluent may include hydrogen and one or more of unreacted methane, carbon monoxide and carbon dioxide. The methane stream may include methane, ethane, propane, or combinations thereof.

The steam reforming unit may include one or more reaction trains. A first reaction train may include electrically heated reforming reactors. The electrically heated reforming reactors may use “green” electricity to produce energy for reforming. “Green” electricity means that no hydrocarbons are used to produce the energy required. The electrically heated reforming reactors may include resistive or inductive heating. Resistive heating may be direct or indirect. In direct resistive heating, heat from a radiant tube of the reformer may be used to heat the mixture of methane and steam. In indirect resistive heating, SiC nickel chrome alloys, iron-nickel-chrome alloys, MoSi₂, or other metallic elements may be used to heat the mixture of methane and steam. For inductive heating, coils transfer heat to a fluid where packing in the coils includes catalysts and inductive materials. An example catalyst may include supported nickel. The catalyst may include inductive materials such as iron, cobalt, or SiC particles. In one or more embodiments, the catalyst does not include inductive materials. The inductive materials and catalysts may be randomly mixed or structured. Heat from the coils is produced by electric power. Microwave powered heaters may also be used.

A second reaction train may include fuel-fired reforming reactors. The fuel-fired reforming reactors may be terrace wall fired, side wall fired, down fired or up fired. The fuel-fired reforming reactors may be fed with hydrogen as a fuel. The hydrogen may be from the reformer effluent produced by the steam reforming unit. The hydrogen may be from the cracker effluent produced by the thermal cracking unit. Using hydrogen produced by the thermal cracking unit or from the steam reforming unit as fuel may result in minimized CO₂ emissions as CO₂ emissions are known to be produced from a hydrocarbon-based fuel.

In one or more embodiments, the fuel-fired reforming reactors may be configured to accept 100% hydrogen to 100% methane as fuel. The amount of hydrogen produced may not be sufficient to power the fuel-fired reforming reactors. Thus, methane may also be used as fuel. When methane is used as fuel, any produced flue gas will contain CO₂. The flue gas may be directed to a carbon capture system to remove any CO₂, thus minimizing any possible CO₂ emissions. In other embodiments, the fuel-fired reforming reactors may be configured to accept a range of fuels. The fuels may include hydrogen, carbon monoxide, methane, ethane, or combinations thereof. The fuels may be separated from the cracker effluent produced by the thermal cracking unit and fed to the fuel-fired reforming reactors of the steam reforming unit. When the fuel includes methane or ethane, purification using a pressure swing adsorption system is required to minimize the CO₂ emissions.

In one or more embodiments, the reforming reactor may be an autothermal reformer. The autothermal reformer may use pure oxygen for combustion air. The oxygen may be imported. The oxygen may also be provided by an air separation unit (ASU). The enriched air (e.g., almost pure oxygen) or pure oxygen may have, for example, an oxygen content of greater than 90 mol %; greater than 95 mol % in other embodiments; greater than 98 mol % in other embodiments; and greater than 99.5 mol % in yet other embodiments.

The steam reforming unit may be configured to reform methane in a methane stream to produce a reformer effluent comprising hydrogen and one or more of unreacted methane, carbon monoxide and carbon dioxide. The steam reforming unit may include reforming reactors and a water-gas shift reactor. Carbon monoxide and hydrogen may be produced in the reforming reactor, as shown in Reaction 1.

CH₄+H₂O→CO+3H₂ (Reaction 1)

The water-gas shift reactor may convert carbon monoxide and water to carbon dioxide and hydrogen. The reaction is the water-gas shift reaction, as shown in Reaction 2.

CO+H₂O→CO₂+H₂ (Reaction 2)

Reformer effluent may be produced after the water-gas shift reaction. The reformer effluent may be separated to recover hydrogen. The amount of carbon dioxide in the reformer effluent may dictate the level of separation required. When CO₂ is low (i.e., when hydrogen is used as fuel in the reforming reactors and methane is used as a feed), less CO₂ capture may be required. The reformer effluent may not need to be separated by a reformer separation system or a pressure swing adsorption system. In these embodiments, the reformer effluent is directed to a cracker separations system to recover hydrogen.

The steam reforming unit may include a reformer separation system. The reformer separation system may be configured to recover a hydrogen stream, a carbon dioxide stream, and an unreacted methane stream. When the amount of CO₂ is higher (i.e., when methane or other hydrocarbons used as the fuel in the reforming reactors and ethane or propane are used as the feed), CO₂ must be captured to minimize CO₂ emissions. In these embodiments, the reformer effluent is directed to the reformer separation system including a carbon capture system to capture CO₂ then directed to the cracker separation system to recover hydrogen. The carbon capture system may include adsorbents such as calcium oxide, caustic, and solvents such as potassium carbonate and amines for adsorbing/absorbing CO₂.

In other embodiments, the reformer effluent is directed to a reformer separation system including a carbon capture system, a pressure swing adsorption system, a membrane adsorption system, or combinations thereof. High purity hydrogen may be recovered from the combination of the carbon capture system, a pressure swing adsorption system, and a membrane adsorption system. Hydrogen may be recovered from the reforming separation system, including the pressure swing adsorption system and the membrane adsorption system, with a purity of at least 99.9 mol %.

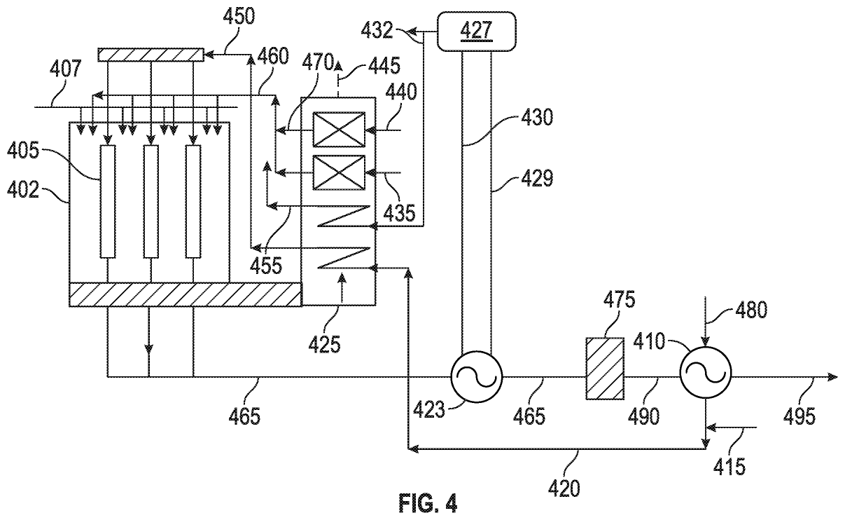

An example system with a fuel-fired reforming reactor is described in FIG. 4. A mixture of methane and steam transported by feed line 480 may flow through a heat exchanger 410. The heat exchanger 410 may be configured to control the temperature of the mixture of methane and steam prior to entering the convection system 425. Reaction steam 415 may be added to the methane and steam mixture and directed via line 420 to the convection system 425. Side-by-side or vertical radiant cells may be used in the convection system 425 to heat the mixture of methane and steam. Flow line 450 may be configured to direct the heated mixture of methane and steam to the fuel-fired reforming reactor 402. Fuel line 407 may be configured to provide a fuel for the fuel-fired reforming reactor 402. Reforming the methane feed may occur at a temperature ranging from 700 to 950° C.

Heat exchanger 423 may be configured to remove heat from the effluent line 465 after reforming. Heat may be transferred to a fluid (i.e., water) and the fluid may be transported via transfer line 429 to a steam drum 427. Steam drum 427 may be used to collect the fluid and separate steam from the steam drum 427 via line 432 for further heating in the convection system 425. Fluid may be recycled back to the heat exchanger 423 via transport line 430. Steam via line 432 may be further heated in the convection system to produce HP or SHP steam in line 455.

Heat may be recovered from flue gas 445 in the convection system 425 to preheat combustion air 435. The heated combustion air may be transported via line 460 for use by the heaters in the fuel-fired reforming reactor 402. The combustion air may be ambient air, preheated air, gas turbine exhaust, and combinations thereof. Boiler feed water (BFW) may also be heated in the convection system 425. BFW may be fed into the convection system via line 440 and transferred out via line 470.

The fuel-fired reforming reactor 402 may include a single or multiple rows of radiant tubes 405. The radiant tubes 405 may include a catalyst. The catalyst may be a catalyst designed for reforming at relatively low pressures (i.e., a low pressure catalyst). In one or more embodiments, the catalyst is a nickel catalyst on aluminum oxide (Ni/Al₂O₃). The catalysts packed in radiant tube 405 may have various shapes. Suitable shapes may include hollow cylinders, monoliths, trilobes, and quadrilobes. Suitable shapes may increase the reaction rate by reducing the diffusion resistance at a low pressure drop.

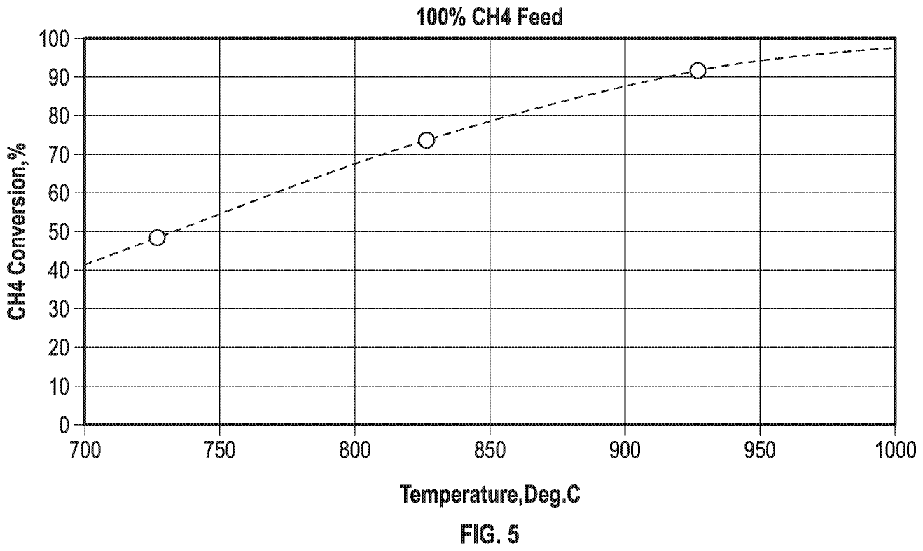

The process of reforming methane and steam into carbon monoxide and hydrogen may occur at a temperature ranging from 700 to 950° C. As indicated in FIG. 5, the higher the temperature, the greater the percent conversion of methane that can occur. The process for reforming methane may occur at a pressure ranging from 5 to 40 bar.

Effluents produced from Reaction 1 may be transferred via effluent line 465 to a water-gas shift reactor 475. Before the water-gas shift reactor 475, the effluents may be cooled through a heat exchanger 423. HP steam may be generated by cooling the effluent. The HP steam may be directed to the steam drum 427 via transfer line 429. The products may be cooled to a temperature ranging from 350 to 500° C. SHP or a combination of SHP and HP steam may also be generated by cooling the effluents.

The water-gas shift reactor 475 may be a tubular reactor or a packed bed reactor operated adiabatically. The water-gas shift reactor 475 may be an adiabatic reactor, The water-gas shift reactor may include a catalyst. The catalyst may be a low pressure drop catalyst. An example catalyst includes iron. The water-gas shift reactor 475 may be configured to operate at a temperature ranging from 350 to 500° C. The catalyst at low temperature may convert all CO to CO₂. The low concentration of remaining CO may remove the need to separate CO from an effluent produced by the water-gas shift reactor 475.

In one or more embodiments, two water-gas shift reactors are used. The first water-gas shift reactor may be configured to operate at a temperature ranging from 400 to 500° C. The second water-gas shift reactor may be configured to operate at a temperature ranging from 250 to 350° C. The first and second water-gas shift reactors may be tubular reactors or packed bed reactors. The first and second water-gas shift reactors may include catalysts. The catalysts may be iron chromium catalysts and copper zinc catalysts. The iron chromium catalysts may be used at high temperatures (i.e., 350 to 500° C.). The copper zinc catalysts may be used at low temperatures (i.e., 250 to 350° C.).

The system may produce a reformer effluent stream. The reformer effluent may be transported by line 490 to heat exchanger 410. Heat exchanger 410 may be configured to lower the temperature of the reformer effluent. Heat removed from the reformer effluent may be used to heat a methane and steam mixture and be directed via line 420 to the convection system 425. The reformer effluent may then be directed via effluent line 495 to a cracker separation system, a reformer separation system, a pressure swing adsorption system, or combinations thereof to recover hydrogen. In one or more embodiments, a recycle line is configured to feed the hydrogen in the reformer effluent to a cracking heater as a hydrogen containing fuel. In other embodiments, the system is configured to feed a portion of the hydrogen in the reforming effluent as a fuel to a reforming reactor of the steam reforming unit.

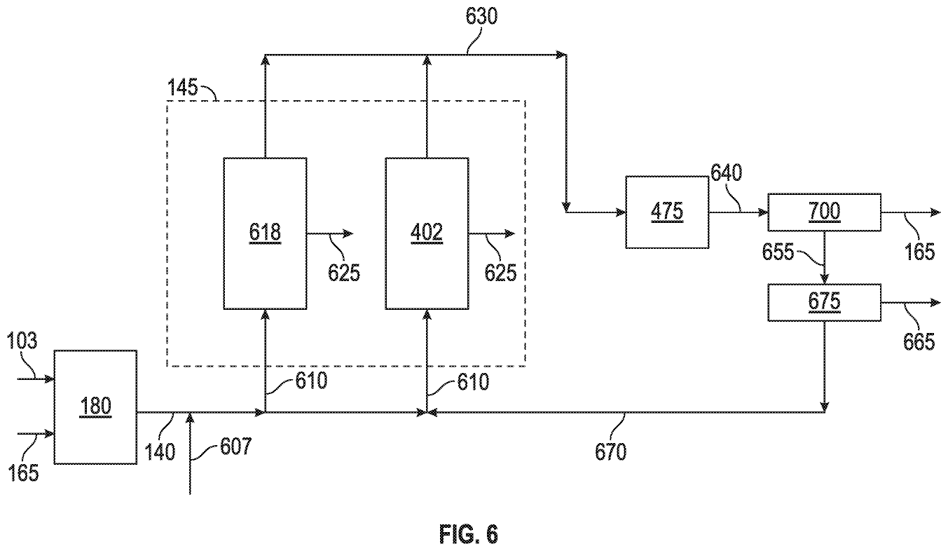

FIG. 6, according to one or more embodiments, shows an example system including a fuel-fired reforming reactor and an electrically heated reforming reactor. The system for minimizing CO₂ emissions may be configured to feed a methane stream 140 to a steam reforming unit including a reformer 145. The methane stream 140 may include other hydrocarbons produced in the thermal cracking unit. For example, ethane, propane, or heavier hydrocarbons may be produced in the ethylene plant. Hydrocarbons produced in the thermal cracking unit and fed to a steam reforming unit may not require contaminant (i.e., sulfur) clean up. The methane stream 140 may be mixed with steam from steam line 607 and fed via line 610 to the reformer 145. The steam may be high pressure (HP) or super high pressure (SHP). HP steam may have a pressure ranging from 40 to 80 bar. SHP pressure may have a pressure of at least 100 bar. The ratio of steam to methane may range from 2:1 to 5:1. In one or more embodiments, the ratio of steam to methane ranges from 2.5:1 to 3.5:1. The reformer 145 may be an autothermal reformer or a conventional reformer. The reformer may be a fuel-fired reforming reactor 402, an electrically heated reforming reactor 618, or combinations thereof. HP steam may be removed after reforming. The HP steam may be integrated back into the process via line 625.

Effluent from the reformer 145 may be directed via line 630 to a water-gas shift reactor 475. Reformer effluent may be provided from the water-gas shift reactor 475. The reformer effluent may include hydrogen, unreacted methane, carbon dioxide, and combinations thereof. The reformer effluent may be directed via effluent line 640 to a pressure swing adsorption system 700. The pressure swing absorption system may separate a hydrogen stream from the reformer effluent. A recycle line 165 may be configured to feed the hydrogen stream to a cracking heater as a hydrogen containing fuel.

A retentate stream may be recovered from the pressure swing adsorption system 700. The retentate stream may include CO, CO₂, and unreacted methane. The retentate stream may be routed via line 655 to a carbon capture system 675. The carbon capture system 675 may include adsorbents for capturing CO₂. Absorbents may be calcium oxide, amines, or caustic adsorbers used in series or parallel. CO₂ may be recovered from the carbon capture system via line 665. An unreacted methane stream may be produced that is separated from the retentate stream and recycled for additional reforming to the reformer 145 via line 670. In one or more embodiments, the system includes a fuel line configured to feed the unreacted methane as a fuel to a reforming reactor of the steam reforming unit, to burners of a thermal cracking unit, or a combination thereof. The pressure swing adsorption system 700 may be bypassed to remove CO₂ only, thereby producing hydrogen-rich fuel that may be used as fuel to the reforming reactor of the steam reforming unit, to burners of the thermal cracking unit, or a combination thereof.

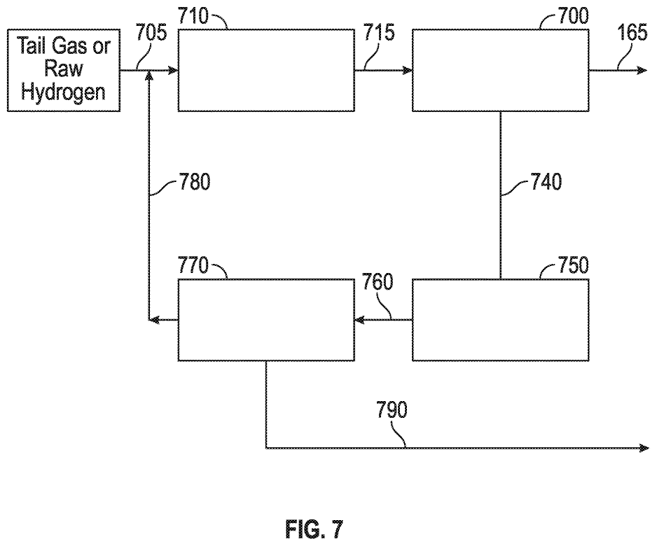

The system may be configured to produce a tail gas. The tail gas may include hydrogen. Hydrogen from the tail gas may be purified using a pressure swing absorption (PSA) system, a membrane adsorption system, or combinations thereof. As shown in FIG. 7, the tail gas may be fed via a feed line 715 at an appropriate pressure to a PSA system 700 for the recovery of a hydrogen stream. The appropriate pressure may range from 20 to 35 barg. The tail gas may first be fed via a feed line 705 to a PSA feed compressor 710 to increase a pressure of the tail gas before the PSA system 700. For example, the tail gas may have a pressure in the range from 1 to 2 barg, and the pressure of the tail gas may be increased to a pressure in the range of 10 to 25 barg. Remaining gases, including any unrecovered hydrogen, may be utilized as a fuel. PSA systems can typically recover 85-90% of the hydrogen, while the balance of hydrogen is permanently lost in the tail gas.

In one or more embodiments, the remaining gases may be further purified using a membrane separation system 770. The remaining gases may be fed to a membrane feed compressor 750 to increase a pressure of the remaining gases. For example, the remaining gases may be recovered in stream 740 at a pressure in the range of 1 to 5 barg, and the pressure of the remaining gases may be increased to a pressure in the range of 10 to 25 barg and then fed via gas stream 760 to the membrane separation system 770.

In the membrane separation system 770, a membrane is used to separate the hydrogen from other gases in the remaining gas stream 740, 760. A hydrogen permeate may be recovered via flow stream 780, while the retentate stream, gases that do not permeate through the membrane, may be recovered as a tail gas stream 790. Hydrogen permeate may then be recycled to the PSA system 700 for recovery of the hydrogen along with hydrogen from feed line 705. Membrane separations systems may recover at least 95% of the hydrogen from the remaining gases. Hydrogen purified by the PSA system 700 and membrane separation system 770 may have a purity of at least 99.9 mol %.

Purified hydrogen from the PSA system 700 may be transported via recycle line 165 as a hydrogen containing fuel for burners in a thermal cracking unit. The purified hydrogen may also be a fuel for fuel-fired reforming reactors in a steam reforming unit. The retentate stream, tail gas stream 790, may be recovered at a pressure, such as in the range of 5 to 15 barg, and this tail gas stream may be used as a fuel gas stream, routed for carbon capture, or as some other purpose gas.

In one or more embodiments, the system for minimizing CO2 emissions when producing olefins via thermal cracking includes a feed line, a fuel line, a cracking heater of a thermal cracking unit, and a cracker separation system. The feed line may be configured to provide a hydrocarbon feed and steam. The fuel line may be configured to provide a hydrogen containing fuel. The cracking heater of the thermal cracking unit may include burners. The burners may be configured to combust the hydrogen containing fuel to provide energy to the cracking heater. The cracker heater may crack the hydrocarbon feed to produce a cracker effluent. In one or more embodiments, the cracker effluent includes hydrogen, methane, C2-C4 olefins, C2-C10 paraffins, naphthenes, aromatics, and pyrolysis fuel oil. The cracker separation system may be configured to separate the cracker effluent to recover a methane stream and one or more hydrocarbon fractions including the C2-C4 olefins, C2-C10 paraffins, and aromatics.

Hydrocarbon feeds useful in embodiments disclosed herein may include various hydrocarbon mixtures having a boiling point range, where the end boiling point of the mixture may be greater than 450° C. or greater than 500° C., such as greater than 525° C., 550° C., or 575° C. The amount of high boiling hydrocarbons, such as hydrocarbons boiling over 550° C., may be as little as 0.1 wt %, 1 wt % or 2 wt %, but can be as high as 10 wt %, 25 wt %, 50 wt % or greater. Processes disclosed herein can be applied to crudes, condensates and hydrocarbons with a wide boiling curve and end points higher than 500° C. Such hydrocarbon mixtures may include whole crudes, virgin crudes, hydroprocessed crudes, gas oils, vacuum gas oils, heating oils, jet fuels, diesels, kerosenes, gasolines, synthetic naphthas, raffinate reformates, Fischer-Tropsch liquids, Fischer-Tropsch gases, natural gasolines, distillates, virgin naphthas, natural gas condensates, atmospheric pipestill bottoms, vacuum pipestill streams including bottoms, wide boiling range naphtha to gas oil condensates, heavy non-virgin hydrocarbon streams from refineries, vacuum gas oils, heavy gas oils, atmospheric residuum, hydrocracker wax, and Fischer-Tropsch wax, among others. In some embodiments, the hydrocarbon mixture may include hydrocarbons boiling from the naphtha range or lighter to the vacuum gas oil range or heavier. If desired, these feeds may be pre-processed to remove a portion of the sulfur, nitrogen, metals, and combinations thereof. Lighter hydrocarbon feeds, such as ethane, propane, butanes, etc., and mixtures of multiple of these various lighter hydrocarbons may also be used as feedstocks to cracking heaters herein.

The thermal cracking reaction proceeds via a free radical mechanism. High ethylene yield may be achieved when hydrocarbons are cracked at high temperatures. Lighter feeds, like butanes and pentanes, require a high reactor temperature to obtain high olefin yields. Heavy feeds, like gas oil and vacuum gas oil (VGO), require lower temperatures. Crude contains a distribution of compounds from butanes to VGO and residue (material having a normal boiling point over 520° C., for example).

Embodiments disclosed herein may include a cracking heater. The cracking heater may be a pyrolysis heater. The cracking heater may include a burner and a reaction zone configured for cracking the hydrocarbon feed to produce the cracker effluent. The burners may be fuel-fired, and the heater may be electrically heated, or combinations thereof. The fuel for the fuel-fired burner may include methane, hydrogen, carbon monoxide, or a mixture thereof. In one or more embodiments, the fuel includes hydrogen in an amount of at least 70 mol % of a total fuel mixture. The power supplied to the electrically heated heater may be “green” electricity, from various renewable resources in which no CO₂ emissions are produced.

In one or more embodiments, the cracking heater is configured to crack hydrocarbons in the hydrocarbon feed to produce a cracker effluent. The system may also be configured to preheat air to feed the cracking heater. Preheating the air may reduce the fuel consumption in the fuel-fired heater. The process may also include preheating the hydrocarbon feed. Embodiments disclosed herein use the convection section of a pyrolysis reactor to preheat the hydrocarbon feed. Steam may be injected at appropriate locations to increase the vaporization of the hydrocarbon feed and to control the heating. The vaporization of the hydrocarbons occurs at relatively low temperatures and/or adiabatically, so that coking in the convection section will be suppressed.

Multiple heating steps may be used to heat the hydrocarbons to a desired temperature. This will permit cracking optimally, such that the throughput, steam to oil ratios, heater inlet and outlet temperatures and other variables may be controlled at a desirable level to achieve the desired reaction results, such as to a desired product profile while limiting coking in the radiant coils and associated downstream equipment.

The cracking heater may be divided into three parts, namely a convection section, a reaction zone, and a quench system. The quench system may be a transfer line exchanger. In the convection section, the hydrocarbon feed is pre-heated, partially vaporized, and mixed with steam. The reaction zone may be configured to crack the hydrocarbon feed. One or more radiant process coils are disposed within the reaction zone, the process coils being heated by the radiant heat from the burners, resulting in the heating and/or conversion of the fluids being processed. The combustion gas passes from the reaction zone to the convective heating section prior to being expelled as a flue gas to the atmosphere. The reacting fluid being cracked is directed to the quench system. In the TLE, the reacting fluid being cracked is quickly quenched to stop the reaction and control the product mixture. Instead of indirect quenching via heat exchange, direct quenching with oil is also acceptable.

Following cracking in the radiant coils, a transfer line exchanger (TLE) may be used to cool the product mixture very quickly and generate steam. One or more coils may be combined and connected to the TLE. The TLE can be double pipe or shell and tube exchanger(s). A quenched cracker effluent may be formed from the quench system.

The quench system may be a part of a cracker separation system. The cracker separation system may also include a first compression system, a first compression system, a caustic wash system, a second compression system, a dryer, a chilling train, a demethanizer, and a pressure swing adsorption system. The first compression system may increase a pressure of the quenched cracker effluent to form a pressurized quenched cracker effluent. The caustic wash system may receive and remove acidic gases from the pressurized quenched cracker effluent to produce a sweetened cracker effluent. Acidic gases may include H₂S, CO₂, NH₃, NOₓ, and combinations thereof. The second compression system may increase the pressure of the sweetened cracker effluent to produce a pressurized sweetened cracker effluent. The dryer may remove water from the pressurized sweetened cracker effluent to produce a dried cracker effluent. The chilling train may reduce a temperature of the dried cracker effluent and separate hydrogen and other non-condensable gases from the methane, C2-C4 olefins, and C2-C10 paraffins, naphthenes, and aromatics to recover a hydrogen containing stream and a hydrocarbon stream including the methane, C2-C4 olefins, and the C2-C10 paraffins, naphthenes, and aromatics. The demethanizer may receive and separate the hydrocarbon stream into a demethanizer methane stream and a C2+ hydrocarbon stream including the C2-C4 olefins and the C2-C10 paraffins, naphthenes, and aromatics. The pressure swing adsorption system may receive and separate the hydrogen containing stream into a hydrogen rich stream and a stream comprising the other non-condensable gases.

The process for minimizing CO₂ emissions when producing olefins via thermal cracking may include feeding the quenched effluent and a reformer effluent to the first compression system for collectively separating. The process may also include feeding the demethanizer stream as the methane stream that is fed to the steam reforming unit. The process may further include feeding the hydrogen containing stream to the cracking heater as the hydrogen containing fuel.

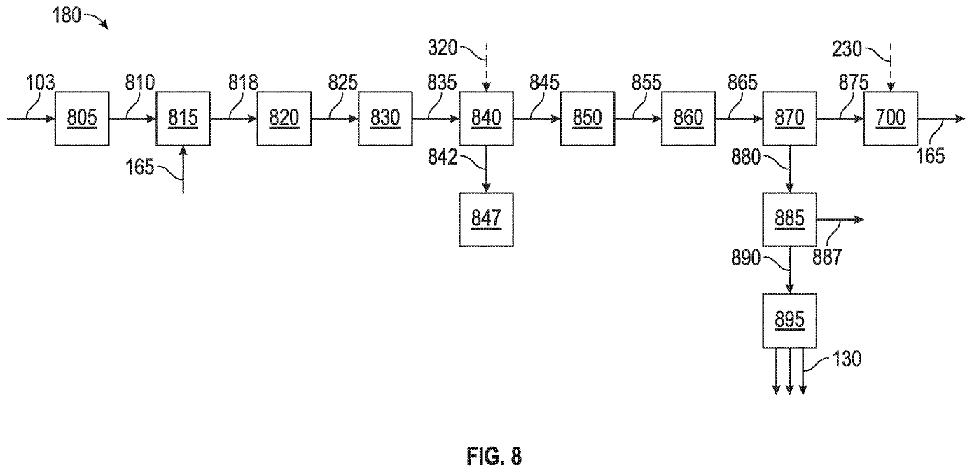

An example thermal cracking unit is depicted in FIG. 8. Feed line 103 may be configured to provide the hydrocarbon feed to the thermal cracking unit 180. Hydrogen may be supplied as fuel for the burners of the cracking heater via recycle line 165. The cracking heater may be divided into three parts, namely a convection section 805, a reaction zone 815, and a quench system 820. The hydrocarbon feed is preheated and mixed with steam in the convection section 805. The hydrocarbon feed is directed to the reaction zone 815 via line 810. After cracking in the reaction zone 815, the cracker effluent is directed to the quench system 820 via line 818. The quench system 820 is configured to reduce the temperature of the cracker effluent to form a quenched cracker effluent.

The quenched cracker effluent may be directed by line 825 to a compression system. The compression system may be a five stage compression system. The first stages of compression may occur in a first compression system 830. The pressurized quenched cracker effluent may be transported via line 835 to a caustic wash system 840. The caustic wash system may absorb CO₂ using caustic to capture CO₂. Amines or calcium oxide may also be used to capture CO₂. A reformer effluent from a steam reforming unit may also be directed to the caustic wash system 840 for CO₂ removal by effluent line 320. H₂S and other sour gases may be separated from the pressurized quenched cracker effluent in a sour gas removal unit 847 via line 842. The remaining sweetened cracker effluent may be directed via line 845 to a second compression system 850 for the final stages of compression. In one or more embodiments, the compression system is a three stage or four stage compression system that includes a caustic wash system.

After the second compression system 850, the thermal cracking unit 180 may be configured to remove water from the pressurized sweetened cracker effluent in dryer 860. Line 855 may direct the compressed products to dryer 860.

The system may be configured, after the dryer, to direct the dried cracker effluent via line 865 to a chilling train 870. The chilling train 870 may reduce temperatures of the dried cracker effluent to allow for separation of hydrogen and other non-condensable gases from the methane, C2-C4 olefins, and C2-C10 paraffins, naphthenes, and aromatics to recover a hydrogen containing stream and a hydrocarbon stream comprising the methane, C2-C4 olefins, and the C2-C10 paraffins, naphthenes, and aromatics. The non-condensable gases may be directed to a pressure swing adsorption system 700 via line 875. The pressure swing adsorption system 700 may also include a membrane separation system. Hydrogen may be recovered from the hydrogen containing stream in the pressure swing adsorption system 700 and fed via recycle line 165 to burners of the cracking heater or a fuel-fired reforming reactor as fuel.

The cracker separation system may include a demethanizer 885. The hydrocarbon stream may be fed to the demethanizer 885 via line 880. The demethanizer may separate the hydrocarbon stream into a demethanizer methane stream 887 and a C2+ hydrocarbon stream including C2-C4 olefins and C2-C10 paraffins, naphthenes, and aromatics. The demethanizer methane stream 887 may have a purity of at least 86 mol %. The methane may be substantially free of sulfur. Substantially free may correspond to less than 5 ppm of sulfur. Referring back to FIG. 1, the demethanizer methane stream 887 may be configured to feed a reformer 145.

The C2+ hydrocarbon stream may be directed via line 890 to a series of distillation columns 895 for recovery of one or more hydrocarbon fractions. Fractions of heavier hydrocarbons 130 may be produced from the distillation columns 895. An ethane stream may be produced from a deethanizer. The deethanizer may separate C2 hydrocarbons from hydrocarbons having three or more carbons. An ethylene stream may be produced from a deethylenizer. The deethylenizer may separate ethylene from the C2 hydrocarbons produced from the deethanizer. A propane stream may be produced from depropanizer. The depropanizer may separate C3 hydrocarbons from hydrocarbons having four or more carbons. A propylene stream may be produced from a depropylenizer. The depropylenizer may separate propylene from the C3 hydrocarbons produced from the depropanizer. A debutanizer may separate C4 hydrocarbons from hydrocarbons having five or more carbons. The C4 hydrocarbons may be further processed to recover one or more separate fractions including 1-butene, 2-butene, butadiene, isobutene, isobutane, n-butane. The hydrocarbons having five or more carbons may be recycled to the cracking heater or processed to recover specific products or fractions. Specific fractions may include naphtha, aromatics, diesel, jet, gas oil, vacuum gas oil, atmospheric or vacuum residues.

In one or more embodiments, the cracker separation system is configured to separate the cracker effluent to recover an ethane stream and a propane stream. A second feed line may feed one or both of the ethane stream and the propane stream to a steam reforming unit. The steam reforming unit may reform the ethane, the propane, or both the ethane and the propane to produce additional hydrogen.

Systems and processes described herein include various integrations for minimizing CO₂ emissions when producing olefins via thermal cracking. One integration may include using a methane stream produced in a thermal cracking unit as a reactant feed for a steam reforming unit. Another integration may include using a methane stream produced in the thermal cracking unit as a fuel for the cracking heater or as a fuel for a reforming reactor of the steam reforming unit.

Integrations described herein may include the recycle of hydrogen. Hydrogen may be produced in the steam reforming unit and in the thermal cracking unit. The hydrogen may be integrated with a cracker heater to use as a fuel. The hydrogen may also be integrated with a reforming reactor to use as fuel. Pure hydrogen, where the purity may be 99.9 mol %, may be provided from a pressure swing adsorption system or a combination of a pressure swing adsorption system with a membrane separation system. Pure hydrogen may be used as a fuel, where the purity produces a minimization of CO₂ emissions, as no hydrocarbons are present in the fuel.

Integrations described herein may also include the use of produced hydrogen and carbon monoxide as fuel. A reformer effluent may include hydrogen, carbon monoxide, and carbon dioxide. The reformer effluent may undergo limited separations with a carbon capture system to recover CO₂. The hydrogen and carbon monoxide remaining may be integrated as a fuel for the cracking heater or as a fuel for a reforming reactor of the steam reforming unit.

Integrations described herein include the use of produced hydrogen, carbon monoxide, and unreacted methane as fuel. A reformer effluent may include hydrogen, carbon monoxide, carbon dioxide, and unreacted methane. The reformer effluent may undergo separations in a carbon capture system and a reformer separation system to recover a carbon dioxide stream. The remaining hydrogen, carbon monoxide, and unreacted methane may be integrated as a fuel for the cracking heater or as a fuel for a reforming reactor of the steam reforming unit. Additional carbon capture systems may be required to minimize CO₂ emissions when a hydrocarbon, such as methane, is used as fuel.

Integrations described herein further include the use of produced ethane and propane. An ethane stream and a propane stream may be produced by the thermal cracking unit. Ethane and propane may be integrated as a feed to the steam reforming unit to produce additional hydrogen. Ethane and propane may be integrated as a recycle feed to a thermal cracking unit to produce additional olefins. Ethane and propane may be integrated as a fuel for the cracking heater or as a fuel for a reforming reactor of the steam reforming unit. One or more of these integrations can be combined in the system.

In one or more embodiments, systems and processes described herein include recycling steam. A steam reforming unit may be configured to generate steam using excess heat in the steam reforming unit. The steam may have a pressure ranging from 40 to 50 bar. The steam pressure may be adjusted to produce SHP, HP, medium pressure (MP), or low pressure (LP) steam. MP steam includes steam with pressures less than 15 bar. LP steam includes steam with pressures less than 5 bar.

In one or more embodiments, a steam line is configured to feed a portion of the steam generated in the steam methane reformer to the cracking unit as a feed steam stream, a utility steam stream, or both as a feed steam stream and a utility steam stream. The steam may be SHP, HP, MP, or LP steam. In other embodiments, the steam line may be configured to be used as dilution steam for diluting hydrocarbons being cracked in the thermal cracking unit. In other embodiments, the steam line may be configured to as a reactant feed for the steam reforming unit. Additional purification steps may be required when the steam is used as a reactant feed. Additional purification steps may include demister pads to remove water droplets. Additional integrations may be used with steam drums for use across both the thermal cracking unit and the steam reforming unit.

Systems and processes described herein may integrate separation systems. For example, as depicted in FIG. 2 and FIG. 8, the reformer effluent may be directed to a caustic wash system or pressure swing adsorption system of a thermal cracking unit for separation. Other integrations may occur depending on the respective steam pressures, compositions, and separation objectives.

As described herein, a steam reforming unit may include a first reaction train including electrically heated reforming reactors and a second reaction train comprising fuel-fired reforming reactors. A system for minimizing CO₂ emissions may include only the electrically heated reforming reactors configured to reform methane to produce start-up hydrogen. The fuel-fired reforming reactors may then be configured to start up by combusting the start-up hydrogen.

A method for starting up an integrated reforming and cracking system may include first reforming methane in an electrically heated reforming reactor to produce hydrogen. Starting up a fuel-fired reforming reactor may use a portion of the hydrogen as a fuel and begin reforming methane in the fuel-fired reforming reactor to produce additional hydrogen. The method may then include starting up a cracking heater using a hydrogen produced in the electrically heated reforming reactor and the fuel-fired reforming reactor and thermally cracking a hydrocarbon feed to produce olefins and methane. Methane produced in the cracking heater may be fed as a methane feed to one or both of the electrically heated reforming reactor and the fuel-fired reforming reactor.

In other embodiments, such as embodiments that do not include an electric reforming reactor, the method for starting up an integrated reforming and cracking system includes first starting up either the fuel-fired reforming reactor or a fuel-fired cracking heater using an imported fuel, such as hydrogen, methane, ethane or other fuels and then transitioning the integrated system to self-fueled operations. For example, the thermal cracking system may be initially fired with imported fuels to produce fuel for both the cracking heater and the reforming reactor, as well as the desired olefins. The method may then include reforming methane to produce hydrogen as described above, and transitioning the cracking heater to self-produce hydrogen fuel.

Systems and processes described herein for minimizing CO₂ emissions when producing olefins via thermal cracking include various methods of carbon capture. CO₂ may be recovered by the methods of carbon capture to minimize CO₂ emissions. Carbon capture may include adsorption/absorption methods using absorbents such as caustic and amines, or adsorbents such as calcium oxide, used in series or parallel. Carbon capture may also include a pressure swing adsorption system, a membrane separation system, and combinations thereof. CO₂ may further be recovered using a cracker separations system.

CO₂ may be captured from a reformer effluent, a cracker effluent, or combinations thereof. CO₂ may be sequestered or converted to other chemicals. Other chemicals may include, but are not limited to, methane and methanol.

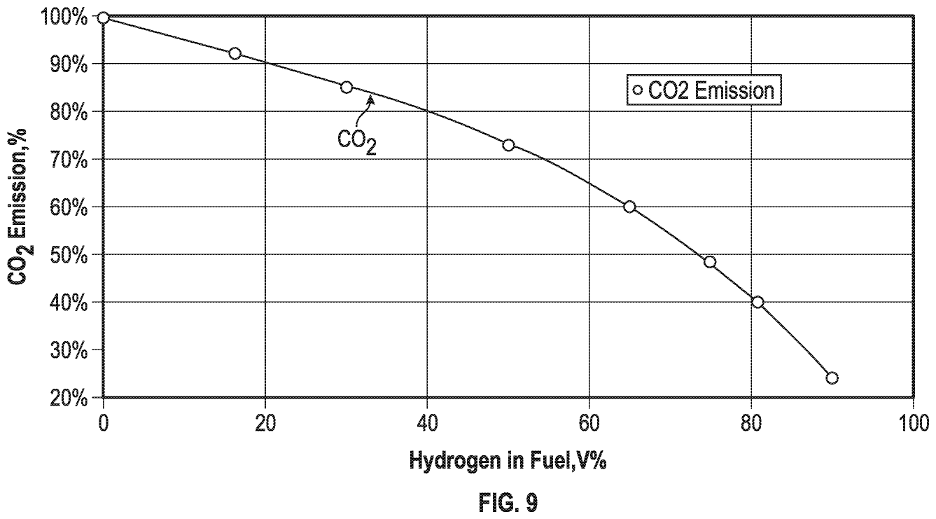

Embodiments of the present disclosure may provide at least one of the following advantages. The systems and processes may minimize CO₂ emissions. The CO2 emissions may be completely eliminated. As shown in FIG. 9, the content of hydrogen in the fuel is related to the level of CO₂ emission reduction required. When a range of 20 to 40% CO₂ emission reduction is required, purification using a PSA unit or methanator may not be required. When 100% CO₂ emission reduction is required, a PSA unit is required because the fuel needs to be 100% hydrogen. A membrane system may also be required. The membrane system may increase the hydrogen recovery. CO₂ emissions may also be reduced by using an electrically heated reforming reactor in a steam reforming unit.

Other advantages from embodiments of the present disclosure may include production of a hydrogen-containing fuel for use in fired heaters. The use of such fuel does not require additional hydrocarbon-based fuels to be imported. This also minimizes CO₂ emissions, as no hydrocarbons are combusted in the fuel. Further, methane produced from the thermal cracking unit may be used for reforming in the steam reforming unit. This methane is substantially sulfur free and this does not require the use of cleanup units. The methane produced in the thermal cracking unit may be sufficient to generate enough hydrogen from the steam reforming unit to result in more than 50% CO₂ emissions. In addition, the process described herein allows for the production of HP steam which may be integrated back into the process, resulting in an overall reduction of energy consumption.

### EXAMPLES

Table 1 shows the overall material balance for 1800 kilo tons annually (KTA) naphtha cracker.

TABLE 1
Material Balance For 1800 KTA Ethylene production

| | |
|---|---|
| Case | 1 |
| FEEDS, KTA | |
| Naphtha | 5055 |
| Net steam reacted | 5 |
| TOTAL | 5060 |
| PRODUCTS, KTA | |
| Hydrogen Product | 33 |
| Methane Rich Offgas | 849 |
| PG Ethylene | 1800 |
| PG Propylene from Cracker | 811 |
| BD Product | 262 |
| Butenes | 189 |
| Butanes | 11 |
| Benzene | 310 |
| C7-C8 Gasoline | 412 |
| C9-205 Gasoline | 121 |
| Pyrolysis Gas Oil | 89 |
| Pyrolysis Fuel Oil | 171 |
| Acid Gases | 4 |
| TOTAL | 5062 |
| C2 Recycle | 281 |
| C3 Recycle | 40 |
| C5-C6 Recycle | 306 |
| As Pure H2 | 50.25 |
| As Pure CH4 | 825.69 |

For this material balance, 8000 hours of operation is assumed. High severity cracking is considered. Typical full range naphtha (specific gravity (SG)=0.72, initial boiling point (IBP)=113F, 50% boiling point=226F, end boiling point (EBP)=325; compositional content, paraffins, non-paraffins, aromatics (P/N/A)=69.1/21.2/9.7 wt %) is used. Both ethane and propane are recycled to extinction and C4 is exported for butadiene extraction and the remaining C4 cut is sold as product. Similarly, from C6-C8, heart cut benzene is extracted and only hydrogenated C5-C6 is recycled back to heaters. Note that hydrogen shown is excess hydrogen (pure) after meeting all hydrogenation requirements. Methane off gas contains some hydrogen also. Methane content in off gas is also shown. This methane is sulfur free and will be sent to hydrogen production.

In Table 2 for 100% H₂ (hydrogen) basis, fuel requirement is shown based on high selective SRT (cracking) heater operating at high severity. Certainly, for all heaters total H₂ fuel demand is 38.087 t/h, but pure H₂ of 6.28 t/h is only available. This is far short and hence for net zero CO₂, a large amount of H₂ (31.8 t/h) has to be imported. This is a large reformer and multiple reactors may be used in converting 826 KTA of methane in SMR.

TABLE 2
Heater Heat Balance

| Feed | Nap + C5-C6 | C2/C3Recy |
|---|---|---|
| HC flow, kg/h | 670035 | 40126 |
| Fired duty, MMKcal/h | 1032 | 81 |
| SHP steam, T/h | 729 | 52 |
| Total Fuel, MMKCal/h | 1113 | |
| Total SOR steam, T/h | 781 | |
| H2 required as fuel, Kg/h | 38087 | |

As shown in Table 2, 103.2 t/h of methane is available. This may produce 51.6 t/h of hydrogen by reforming. However, in most SMR plants methane conversion is well below 80%. Therefore, unconverted methane can be recycled back to the reformer after removing CO₂ and hydrogen. Or it can be sold/used as fuel. Methane available is more than sufficient to produce 38 T/h of hydrogen. Still excess H₂ is available and that can be used in the reformer to cut down the CO₂ emission.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A process for minimizing carbon dioxide emissions when producing olefins via thermal cracking, the process comprising:
providing a hydrocarbon feed and a hydrogen containing fuel to a cracking heater of a thermal cracking unit;
combusting the hydrogen containing fuel in burners of the cracking heater to provide energy to crack the hydrocarbon feed to produce a cracker effluent comprising hydrogen, methane, C2-C4 olefins, C2-C10 paraffins, naphthenes, and aromatics, and pyrolysis fuel oil;
separating the cracker effluent to recover a methane stream and one or more hydrocarbon fractions comprising the C2-C4 olefins, and the C2-C10 paraffins, naphthenes and aromatics;
feeding the methane stream to a steam reforming unit;
reforming the methane in the steam reforming unit to produce a reformer effluent comprising hydrogen and one or more of unreacted methane, carbon monoxide, and carbon dioxide; and
feeding the hydrogen in the reformer effluent to the cracking heater as the hydrogen containing fuel.

2. The process of claim 1, further comprising feeding a portion of the hydrogen in the reformer effluent as a fuel to a reforming reactor of the steam reforming unit.

3. The process of claim 1, wherein the reformer effluent comprises hydrogen, unreacted methane, and carbon dioxide, the process further comprising:
feeding the reformer effluent to a reformer separation system to recover a hydrogen stream, a carbon dioxide stream, and an unreacted methane stream; and
feeding the hydrogen stream to the cracking heater as the hydrogen containing fuel.

4. The process of claim 3, further comprising feeding the unreacted methane stream to a reactor of the steam reforming unit for continued conversion.

5. The process of claim 3, further comprising feeding the unreacted methane as a fuel to reforming reactors of the steam reforming unit, to burners of the thermal cracking unit, or a combination thereof.

6. The process of claim 1, wherein the reformer effluent comprises hydrogen, unreacted methane, carbon monoxide and carbon dioxide, the process further comprising:
feeding the reformer effluent and the cracker effluent to a cracker separation system; and
collectively separating the cracker effluent and the reformer effluent to recover a carbon dioxide stream, the methane stream, and a hydrogen stream;
wherein feeding the hydrogen in the reformer effluent comprises feeding the hydrogen stream to the cracking heater as the hydrogen containing fuel.

7. The process of claim 6, wherein the cracker separation system comprises:
a quench system for receiving and reducing a temperature of the cracker effluent to form a quenched cracker effluent;
a first compression system for increasing a pressure of the quenched cracker effluent to form a pressurized quenched cracker effluent;
a caustic wash system for receiving and removing acidic gases from the pressurized quenched cracker effluent to produce a sweetened cracker effluent;
a second compression system for increasing a pressure of the sweetened cracker effluent to produce a pressurized sweetened cracker effluent;
a dryer for removing water from the pressurized sweetened cracker effluent to produce a dried cracker effluent;
a chilling train to reduce a temperature of the dried cracker effluent and for separating hydrogen and other non-condensable gases from the methane, C2-C4 olefins, and C2-C10 paraffins, naphthenes, and aromatics to recover a hydrogen containing stream and a hydrocarbon stream comprising the methane, C2-C4 olefins, and C2-C10 paraffins, naphthenes and aromatics;
a demethanizer for receiving and separating the hydrocarbon stream into a demethanizer methane stream and a C2+ hydrocarbon stream comprising the C2-C4 olefins, and C2-C10 paraffins, naphthenes, and aromatics; and
a pressure swing adsorption system for receiving and separating the hydrogen containing stream into a hydrogen rich stream and a stream comprising the other non-condensable gases;
wherein the process comprises:
feeding the quenched cracker effluent and the reformer effluent to the first compression system for the collectively separating;
feeding the demethanizer methane stream as the methane stream fed to the steam reforming unit; and
feeding the hydrogen containing stream to the cracking heater as the hydrogen containing fuel.

8. The process of claim 1, wherein the reformer effluent comprises hydrogen, unreacted methane, carbon monoxide and carbon dioxide, the process further comprising:
feeding the reformer effluent to a reformer separation system to produce a carbon dioxide stream and a CO2-lean stream comprising hydrogen, carbon monoxide, and unreacted methane;
feeding the cracker effluent to a first cracker separation system to produce a hydrogen-rich stream and a hydrocarbon-rich stream; and
feeding the CO2-lean stream and the hydrogen-rich stream to a second cracker separation system, and collectively separating the CO2-lean stream and the hydrogen-rich stream to recover a hydrogen stream and a retentate stream comprising the unreacted methane;
wherein feeding the hydrogen in the reformer effluent comprises feeding the hydrogen stream to the cracking heater as the hydrogen containing fuel.

9. The process of claim 1, wherein the separating the cracker effluent comprises recovering an ethane stream and recovering a propane stream, the process further comprising:
feeding one or both of the ethane stream and the propane stream to the steam reforming unit; and
reforming the ethane, the propane, or both the ethane and the propane to produce additional hydrogen.

10. The process of claim 1, wherein the steam reforming unit comprises:
a first reaction train comprising electrically heated reforming reactors; and
a second reaction train comprising fuel-fired reforming reactors;
wherein the process further comprises:
reforming methane in only the electrically heated reforming reactors to produce start-up hydrogen; and
starting up the fuel-fired reforming reactors by combusting the start-up hydrogen.

11. The process of claim 1, further comprising:
generating steam using excess heat in the steam reforming unit; and
feeding a portion of the steam generated in the steam reforming unit to the thermal cracking unit as a feed steam stream, a utility steam stream, or both as a feed steam stream and a utility steam stream.

12. A system for minimizing carbon dioxide emissions when thermally cracking hydrocarbons to produce olefins, the system comprising:
a feed line configured to provide a hydrocarbon feed and steam;
a fuel line configured to provide a hydrogen containing fuel;
a cracking heater of a thermal cracking unit comprising burners configured to combust the hydrogen containing fuel to provide energy to the cracking heater to crack the hydrocarbon feed and produce a cracker effluent comprising hydrogen, methane, C2-C4 olefins, C2-C10 paraffins, naphthenes, and aromatics, and pyrolysis fuel oil;
a cracker separation system configured to separate the cracker effluent to recover a methane stream and one or more hydrocarbon fractions comprising the C2-C4 olefins and the C2-C10 paraffins, naphthenes and aromatics;
a steam reforming unit configured to reform methane in the methane stream to produce a reformer effluent comprising hydrogen and one or more of unreacted methane, carbon monoxide and carbon dioxide; and
a recycle line configured to feed the hydrogen in the reformer effluent to the cracking heater as the hydrogen containing fuel.

13. The system of claim 12, further configured to feed a portion of the hydrogen in the reformer effluent as a fuel to a reforming reactor of the steam reforming unit.

14. The system of claim 12, wherein the reformer effluent comprises hydrogen, unreacted methane, and carbon dioxide, the system further comprising:
an effluent line configured to feed the reformer effluent to a reformer separation system;
the reformer separation system configured to recover a hydrogen stream, a carbon dioxide stream, and an unreacted methane stream; and
a second fuel line configured to feed the hydrogen stream to the cracking heater as the hydrogen containing fuel.

15. The system of claim 14, further comprising a second recycle line configured to feed the unreacted methane stream to a reformer of the steam reforming unit for continued conversion.

16. The system of claim 14, further comprising a third fuel line configured to feed the unreacted methane stream as a fuel to a reforming reactor of the steam reforming unit, to burners of the thermal cracking unit, or a combination thereof.

17. The system of claim 12, wherein the reformer effluent comprises hydrogen, unreacted methane, carbon monoxide and carbon dioxide, the system further comprising:
an effluent line configured to feed the reformer effluent and the cracker effluent to a cracker separation system;
the cracker separation system configured to separate the cracker effluent and reformer effluent to recover a carbon dioxide stream, the methane stream, and a hydrogen stream; and
a second fuel line configured to feed the hydrogen in the reformer effluent to the cracking heater as the hydrogen containing fuel.

18. The system of claim 17, wherein the cracker separation system comprises:
a quench system to receive and reduce a temperature of the cracker effluent to form a quenched cracker effluent;
a first compression system to increase a pressure of the quenched cracker effluent to form a pressurized quenched cracker effluent;
a caustic wash system to receive and remove acidic gases from the pressurized quenched cracker effluent to produce a sweetened cracker effluent;
a second compression system to increase a pressure of the sweetened cracker effluent to produce a pressurized sweetened cracker effluent;
a dryer to remove water from the pressurized sweetened cracker effluent to produce a dried cracker effluent;
a chilling train to reduce a temperature of the dried cracker effluent and to separate hydrogen and other non-condensable gases from the methane, C2-C4 olefins, and C2-C10 paraffins, naphthenes, and aromatics to recover a hydrogen containing stream and a hydrocarbon stream comprising the methane, C2-C4 olefins, and C2-C10 paraffins, naphthenes and aromatics;
a demethanizer to receive and separate the hydrocarbon stream into a demethanizer methane stream and a C2+ hydrocarbon stream comprising the C2-C4 olefins and C2-C10 paraffins, naphthenes, and aromatics; and
a pressure swing adsorption system to receive and separate the hydrogen containing stream into a hydrogen rich stream and a stream comprising the other non-condensable gases;
wherein:
the first compression system is configured to receive the quenched cracker effluent and the reformer effluent for collective separation;
the methane stream from the demethanizer methane stream is directed to the steam reforming unit; and
the hydrogen containing stream is directed to the cracking heater as the hydrogen containing fuel.

19. The system of claim 12, wherein the cracker separation system is configured to separate the cracker effluent to recover an ethane stream and a propane stream, the system further comprising:
a second feed line configured to feed one or both of the ethane stream and the propane stream to the steam reforming unit to reform the ethane, the propane, or both the ethane and the propane to produce additional hydrogen.

20. The system of claim 12, wherein the steam reforming unit comprises:
a first reaction train comprising electrically heated reforming reactors; and
a second reaction train comprising fuel-fired reforming reactors;
wherein the system further comprises:
only the electrically heated reforming reactors configured to reform methane to produce start-up hydrogen; and
the fuel-fired reforming reactors configured to start up by combusting the start-up hydrogen.

21. The system of claim 12, further comprising:
the steam reforming unit configured to generate steam using excess heat in the steam reforming unit; and
a steam line configured to feed a portion of the steam generated in the steam reforming unit to the thermal cracking unit as a feed steam stream, a utility steam stream, or both as a feed steam stream and a utility steam stream.

22. A method for starting up an integrated reforming and cracking system, the method comprising:
reforming methane in an electrically heated reforming reactor to produce hydrogen;
starting up a fuel-fired reforming reactor using a portion of the hydrogen as a fuel and reforming methane in the fuel-fired reforming reactor to produce additional hydrogen;
starting up a cracking heater using a hydrogen produced in the electrically heated reforming reactor and the fuel-fired reforming reactor and thermally cracking a hydrocarbon feed to produce olefins and methane; and
feeding the methane produced in the cracking heater as methane feed one or both of the electrically heated reforming reactor and the fuel-fired reforming reactor.
